(19) United States
(12) Patent Application Publication
(10) Pub. No.: US 2024/0246136 A1
(43) Pub. Date: Jul. 25, 2024

(54) MODULAR FORMING TOOL, MODULAR FORMING TOOL SET, PRESS TOOL SYSTEM AND METHOD OF MAKING MODULAR FORMING TOOL

(71) Applicant: KAMAX Holding GmbH & Co. KG, Homberg (Ohm) (DE)

(72) Inventors: Roy Finsterbusch, Frankenberg (DE); Christian Ludwig, Darmstadt (DE); Hilmar Gensert, Bad Düben (DE); Robert Sturm, Homberg (Ohm) (DE)

(21) Appl. No.: 18/253,497

(22) PCT Filed: Nov. 3, 2021
(86) PCT No.: PCT/EP2021/080541

§ 371 Date: May 18, 2023

(30) Foreign Application Priority Data
Nov. 13, 2020 (DE) 10 2020 129 954.0

(51) Int. Cl. B21D 37/02; B23P 15/24

(52) U.S. Cl. CPC B21D 37/02; B23P 15/24

(57) ABSTRACT

A modular forming tool for the production of essentially rotationally symmetrical parts, includes at least one primary tool and at least one reinforcing tube. The forming tool extends along a longitudinal extension direction and has a workpiece machining surface, a sheath surface, and two end surfaces. The workpiece machining surface contacts or is adapted to contact a workpiece, where the sheath surface bounds the primary tool in a radial direction and the end surfaces bound the primary tool in the longitudinal extension direction. The sheath surface of the primary tool is at least partially conical in shape, such that the inner sheath surface of the reinforcing tube is at least partially conical for the inner sheath surface to contact the sheath surface.

The invention relates to a die module and a press tool system, in particular for producing essentially rotationally symmetrical parts by forming.

Die modules for press tools are already known from the prior art. These die modules usually consist of a core and several reinforcing rings which surround the core and absorb the forces acting on the core, at least in part. The number of reinforcement rings increases the pretensioning force on the core that can be achieved by the die module, so that several reinforcement rings are used for high loads. In the prior art, it is known to secure the reinforcement rings and the core against displacement in the direction of the contact force by means of a friction-locked connection. However, such frictional connections allow relatively low force transmission between the core and the nearest reinforcing ring and/or between radially adjacent reinforcing rings. Therefore, only a relatively low forming force can be applied in the already known die modules.

It is therefore the task of the invention to provide a tool module that can absorb a high level of forces in the axial direction.

This task is solved by a modular forming tool for a press tool according to claim 1, by a modular forming tool set according to claim 8, by a press tool system according to claim 9 and by a method for manufacturing a modular forming tool according to claim 10. Further advantages, features and advantageous embodiments result from the subclaims, the description and the figures.

According to the invention, a modular forming tool, in particular a press tool, is preferably provided for the production of a essentially rotationally symmetrical part, wherein the modular forming tool comprises at least one primary tool, in particular a core, and at least one reinforcing tube, wherein the forming tool extends along a longitudinal direction of extension, wherein the primary tool has a workpiece machining surface, a sheath surface and two end surfaces, wherein the workpiece machining surface contacts or is designed to contact a workpiece, wherein the sheath surface bounds the primary tool in a radial direction, wherein the end surfaces bound the primary tool in the longitudinal extension direction, wherein the sheath surface of the primary tool is at least partially, preferably predominantly, conical in shape, wherein the reinforcing tube has an inner sheath surface and an outer sheath surface, wherein the inner sheath surface is at least partially, preferably predominantly, particularly preferably completely, conical in shape, and wherein the inner sheath surface contacts the sheath surface. The modular forming tool is in particular a pressing tool and/or a component of a pressing tool. The modular forming tool serves fundamentally to be used in a forming manufacturing step or in a forming manufacturing process. Preferably, the modular forming tool is used to produce essentially rotationally symmetrical parts, such as bolts and/or screws and/or eccentric screws. These essentially rotationally symmetrical parts are in particular parts which are preferably at least in sections rotationally symmetrical about an axis, although these parts may have spiral-like external contours, such as a thread, or tool engagement contours which may destroy or break the perfect rotational symmetry of these parts. For example, in this context, bolts, eccentric bolts or screws, among others, are essentially rotationally symmetrical parts within the meaning of the invention. In other words, the modular forming tool may be used to form a workpiece such that an essentially rotationally symmetrical part such as a bolt or screw is created from a blank. The modular forming tool comprises a plurality of different modules or components, wherein the modular forming tool comprises at least one primary tool and at least one reinforcing tube, preferably a plurality of reinforcing tubes. Additionally, the modular forming tool may comprise auxiliary tools. The modular forming tool extends along a longitudinal extension direction. In particular, the longitudinal extension direction of the forming tool is the direction in which the length of the modular forming tool is determined and/or around which the forming tool is built. In other words, the forming tool and/or the reinforcing tubes and/or the auxiliary tools and/or the primary tools may be arranged in an assembled state such that they surround or enclose the longitudinal extension direction. Alternatively or additionally preferably, the longitudinal extension direction can also be the direction in which the workpiece mainly extends and/or in which the forming tool moves during the forming of the workpiece. The primary tool of the modular forming tool is used to contact the workpiece processing surface of the primary tool with a workpiece in such a way that the workpiece is formed by this contact. In other words, this may mean that the workpiece processing surface is a surface of the primary tool that contacts or can contact the workpiece for forming the workpiece. In particular, the primary tool is formed as a core, preferably made of hard metal. By a core it can be understood in this context that the primary tool is in particular of such a nature that, viewed in the radial direction, it at least partially forms an inner core of the modular forming tool, which is, however, preferably hollow (e.g. tubular). In particular, therefore, the primary tool is formed in such a way that the workpiece machining surfaces and/or the workpiece machining surface of the primary tool delimit or bound the primary tool inwardly in the radial direction. In addition to the workpiece machining surface or the workpiece machining surfaces, the primary tool also has a sheath surface and two end surfaces. The sheath surface limits the primary tool in the radial direction, in particular outwardly. In other words, this can mean that the sheath surface forms the part of the respective primary tool facing outward in the radial direction. Advantageously, the radial direction extends perpendicular to the longitudinal extension direction. In other words, this can mean that the radial direction points radially away from the longitudinal extension direction. The sheath surface of the primary tool is at least partially conical in shape. By a partially conical formation, it can be understood fundamentally that at least a part of the relevant surface, in this case the sheath surface, corresponds to a surface of rotation about an axis, in particular about the longitudinal extension direction. In other words, this can mean that the conical surface is a surface whose shape corresponds to the geometry that results from a rotation of a curve with a slope that is at least in sections not equal to zero in relation to the axis of rotation, about a (rotation) axis, in particular the axis or axis of rotation is the longitudinal extension direction. Advantageously, the conical portion of the sheath surface, preferably the entire sheath surface, is formed in such a way that it is monotonous, in particular strictly monotonous, in the direction of longitudinal extension, in particular in the positive direction of longitudinal extension. By a monotonous conical surface is meant a conical surface which along its axis, about which the surface is rotationally symmetrical, has a monotonically increasing distance to this (rotational) axis. In other words, the conical surface can therefore be formed monotonically, in particular strictly monotonically, increasing along the longitudinal direction of extension in a sectional plane which is spanned in particular by the longitudinal direction of extension and the radial direction. In this way, a particularly simple joining of the conical surface to a contacting component can be achieved, in particular also in the case of a cold joining without heating up the and/or one of the components to be joined. Preferably, therefore, the sheath surface is formed at least essentially rotationally symmetrical to or about the longitudinal extension direction and advantageously also has an increasing distance from the longitudinal extension direction in the longitudinal extension direction. Preferably, the sheath surface is formed substantially completely conical, although this can also be described as predominantly conical. By a substantially completely conical formation it is to be understood that more than 80%, preferably more than 90% and particularly preferably more than 95% of the relevant surface is conically formed. In this way, a particularly mechanically loadable form-fit support can be achieved. The conical surface of the sheath surface is designed to contact an inner sheath surface of a reinforcing tube in an assembled state in order to transmit forces between the primary tool and the reinforcing tube in the direction of longitudinal extension. In the longitudinal direction, the primary tool is limited by the end surfaces. In particular, the end surfaces are such that they have a normal which is essentially parallel to the longitudinal extension direction. In other words, the end surfaces of the primary tool are substantially planar, wherein this plane in which the respective end surface lies has a normal which is essentially parallel to the direction of longitudinal extension. Essentially parallel in the sense of the invention are two directions in particular if the included angle between these two directions is at most 3° preferably at most 1.5° and particularly preferably at most 0.75° and especially strongly preferred at most 0.2°. Advantageously, the modular forming tool has a plurality of primary tools, in particular 2, 3 or 4 primary tools, which advantageously can all have the features described above and below. Advantageously, these primary tools are designed or arranged within the modular forming tool in such a way that they each have an end surface which directly contacts an end surface of a further primary tool. In other words, this can mean that the primary tools can be arranged next to or behind each other in the longitudinal direction in such a way that they make direct contact with each other. In this way, a particularly compact modular forming tool can be achieved. Advantageously, each of these primary tools forms part of a core of the modular forming tool. In addition to the primary tool, the modular forming tool also comprises at least one reinforcing tube. The reinforcing tube has an inner sheath surface and an outer sheath surface. The inner sheath surface limits the reinforcing tube inwardly in the radial direction and the outer sheath surface limits the reinforcing tube outwardly in the radial direction. It is expedient that the inner sheath surface and/or the outer sheath surface of the reinforcing tube, preferably of all reinforcing tubes, is/are formed at least essentially rotationally symmetrical to or about the longitudinal extension direction. This essentially rotationally symmetrical design of the inner sheath surface and/or the outer sheath surface of the reinforcing tube or of all the reinforcing tubes of the forming tool can result in a particularly high mechanical load-bearing capacity of the reinforcing tube and enable the reinforcing tubes to be manufactured at particularly low cost. In an assembled state, the reinforcing tubes are arranged in particular in such a way that they contact and at least partially surround a primary tool and/or a further reinforcing tube with their inner sheath surface. The outer sheath surfaces of the reinforcing tube or tubes, on the other hand, serve to support the reinforcing tube relative to surrounding reinforcing tubes and/or mounts. The reinforcing tubes may therefore be arranged, particularly in an assembled state, relative to the primary tool(s) and/or relative to other reinforcing tubes in a manner similar to onion rings in an onion. The reinforcing tube(s) is/are therefore designed to be closed in the circumferential direction, in particular, in order to achieve a high load-bearing capacity of the reinforcing tube. By a “closed” design it is to be understood that the outer sheath surface is not connected to the inner sheath surface, for example, by recesses such as slots or holes. Advantageously, the modular forming tool is bounded on the outside by a holder which serves in particular to be arranged in a tool holder or in a machine tool in a supporting manner. Advantageously, the receptacle therefore limits the modular forming tool in the radial direction. The at least one reinforcing tube, preferably all reinforcing tubes, has an at least partially conical inner sheath surface. This at least partially conical inner sheath surface serves to positively, and advantageously at the same time also non-positively, secure a displacement of the component directly surrounded in the radial direction and—in an assembled state—contacting against a relative displacement in the longitudinal extension direction. Therefore, the components contacting the conical inner sheath surface are advantageously formed in this contacting area complementary to the inner sheath surface and are thus also formed at least conically in this area in order to achieve a form-fit positional securing. According to the invention, it is therefore at least provided that the conically formed part of the inner sheath surface of the reinforcing tube contacts the sheath surface, in particular the conically formed part of the sheath surface, of the primary tool. Through this, the invention is able to positively prevent any displacement between the reinforcing tube and the primary tool. Advantageously, however, each reinforcing tube of the forming tool is designed in such a way that they each have substantially completely conical inner and/or outer sheath surfaces. In this way, it can be achieved that relative displacement is positively prevented between the reinforcing tubes and the components (primary tools and/or reinforcing tubes) directly surrounded by them in each case. Therefore, in other words, it is advantageous if the components directly surrounded by a reinforcing tube and contacting the inner sheath surface of the reinforcing tube in an assembled state, in particular further reinforcing tubes and/or primary tools, are designed to be complementary to the inner sheath surface of the surrounding and contacting reinforcing tube with regard to the contacting surfaces, in particular the outer sheath surface of the reinforcing tube and/or the sheath surface of the primary tool.

Advantageously, the at least one, preferably all, reinforcing tubes are designed in such a way that in an assembled state they form an interference fit with the directly surrounded component, in particular another reinforcing tube or a primary tool. By forming the contacting areas as an interference fit, a particularly secure positional retention can be achieved in both positive and negative longitudinal extension directions. In other words, the modular forming tool can be designed in such a way that, in one direction, positive and non-positive displacement securing is ensured between the reinforcing tube and the component surrounded by the reinforcing tube, and in the other direction of longitudinal extension, only non-positive displacement securing in the direction of longitudinal extension is achieved.

Advantageously, the modular forming tool comprises a plurality of reinforcing tubes, wherein expediently the inner sheath surfaces of the predominant part of the, in particular all, reinforcing tubes are at least partially, preferably predominantly, conical. By providing a plurality, in particular of 3, 4, 5, 8 or 10 reinforcing tubes, it can be achieved that a high degree of forces can be absorbed in the circumferential direction by the plurality of reinforcing tubes.

The circumferential direction is in particular the direction which is formed circumferentially around the longitudinal extension direction. In general, the longitudinal direction, the radial direction and the circumferential direction therefore form a cylinder coordinate system with each other.

It is expedient for the modular forming tool to have an outer receptacle, the receptacle having an inner contact surface, wherein preferably at least one reinforcing tube contacts the inner contact surface with its outer sheath surface, wherein the inner contact surface is in particular at least partially, preferably predominantly, conical. The receptacle is in particular that component of the modular forming tool which delimits it outwardly in the radial direction. Advantageously, the receptacle is designed in such a way that it is limited outwardly in the radial direction by only cylindrical surfaces in order to achieve the most cost-effective design possible. The receptacle can have a shoulder with respect to its outer surrounding surface, this shoulder being formed in particular in an end region viewed in the longitudinal direction. In this way, a stop surface can be formed by the shoulder in the longitudinal direction in order to achieve a positive locking of the receptacle in the longitudinal direction. The inner contact surface of the receptacle is used to make direct contact with a reinforcing tube. This makes it possible to achieve a particularly compact arrangement. Advantageously, the inner contact surface is at least partially, preferably predominantly, conical. This makes it possible to achieve positive support of the reinforcing tubes or the reinforcing tube relative to the receptacle in a particularly compact design. Advantageously, the inner contact surface is complementary to the directly surrounding and contacting outer sheath surface of the outer reinforcing tube.

Advantageously, at least one reinforcing tube, preferably all reinforcing tubes, is/are designed in such a way that it/they has/have a conical outer sheath surface. As a result, the reinforcing tubes can not only absorb or transmit a force inwardly in a form-fitting manner, but can also ensure or provide a form-fitting—and thus safe—force transmission with respect to the exposed contact partner or the immediately surrounding contact partner. In other words, the reinforcing tubes of the forming tool can not only have a conically formed inner sheath surface, but also a conically formed outer sheath surface. Therefore, at least one reinforcing tube, preferably all reinforcing tubes, of the forming tool may be bounded by conical surfaces in the radial inward direction and in the radial outward direction (away from the longitudinal extension direction). Advantageously, in the case of the reinforcing tubes which have a conical outer sheath surface, the outer sheath surface is essentially completely conical. In this way, a particularly safe transmission of force can be achieved. It is particularly preferred if the conical surfaces of the inner and outer sheath surfaces of the reinforcing tubes, which have a conical outer and inner sheath surface, are concurrently conical in the longitudinal direction. In this context, “concurrently conical” can mean that the conically formed surfaces of the reinforcing tube each have the same sign in their gradient relative to the longitudinal direction, as viewed in the longitudinal direction. In other words, this can mean that a “concurrently conical” is given in particular when both the outer and inner sheath surfaces are increasingly spaced apart from the longitudinal extension direction in positive longitudinal extension direction. The “concurrently conical” design can ensure that the positive locking of the reinforcing tube is achieved by both the outer sheath surface and the inner sheath surface in each case in the same longitudinal direction of extension (+/−).

It is expedient that the reinforcing tubes—or at least one of the reinforcing tubes—each have a constant wall thickness. This results in a particularly simple and cost-effective production of the reinforcing tubes. The decisive wall thickness is the average wall thickness of the reinforcing tube in a cross section perpendicular to the longitudinal direction. In other words, the wall thickness of the reinforcing tubes or the reinforcing tube does not change along the longitudinal direction. With regard to this, however, it should be emphasized that the reinforcing tubes can have different wall thicknesses in relation to one another.

The forming tool expediently has at least two reinforcing tubes, wherein the at least two reinforcing tubes advantageously are designed in such a way that one reinforcing tube surrounds the other reinforcing tube, in particular directly, wherein the maximum inner diameter of the inner sheath surface of the surrounded reinforcing tube corresponds, at least substantially, to the minimum inner diameter of the inner sheath surface of the nearest surrounding or directly surrounding reinforcing tube. Through this, a modularization of the reinforcing tubes can be achieved, so that the space required for the storage of the reinforcing tubes can be reduced, resulting in a cost-effective modular forming tool. In addition, this can also reduce the manufacturing cost of the forming tool. The maximum inner diameter of the inner sheath surface is the largest diameter which the inner sheath surface has along the longitudinal direction of extension to itself. The minimum inner diameter of the inner sheath surface is, however, the smallest diameter which the inner sheath surface has along the longitudinal extension direction. By “substantially corresponding” it can be understood that the diameters have a deviation of at most 5%, preferably of at most 2% and particularly preferably of at most 1% and especially strongly preferred of at most 0.5%.

Advantageously, the conical inner sheath surface of the reinforcing tube, in particular of all reinforcing tubes, forms a cone angle with the longitudinal extension direction, wherein the cone angle lies in particular in a range from 0.5° to 8°, preferably in a range from 1° to 5° and particularly preferably in a range from 2° to 4°. The conical portion of the inner sheath surface of the reinforcing tube is therefore advantageously formed by the “imaginary” rotation of a straight line about the longitudinal extension direction, wherein the straight line has a constant pitch in the longitudinal extension direction. Due to this, in particular constant, cone angle of the inner sheath surface, a particularly simple production, in particular by turning, of the conical inner sheath surface of the reinforcing tube can be achieved. Advantageously, all conical inner sheath surfaces of all reinforcing tubes of the modular forming tool are therefore formed in such a way that they form a, in particular constant, cone angle with the longitudinal extension direction. To achieve particularly simple production, the cone angle should lie in a range of 0.5°-8°. With a cone angle in the range of 1°-5°, a particularly good compromise can be achieved between the force required for the joint and the possible force which the reinforcing tube can transmit in the longitudinal extension direction in a form-fitting manner with its contacting partner via the inner sheath surface. Surprisingly, the applicant has found that at a cone angle in the range of 2°-4°, particularly good joinability of the reinforcing tube can be achieved in a cold jointing (or cold joining) operation, hence this can facilitate joining without heating or cooling of the reinforcing tube. The cone angle of the inner sheath surface can also be referred to as the first cone angle or the inner cone angle.

Advantageously, the conical outer sheath surfaces of the reinforcing tube(s) form a second, in particular constant, cone angle with the longitudinal extension direction, wherein the second cone angle lies in particular in a range of 0.5°-8°, preferably in a range of 1°-5° and particularly preferably in a range of 2°-4°. Hereby, in an analogous manner, the advantages and/or embodiments already elaborated above can be achieved with respect to the (first) cone angle. The second cone angle can also be referred to as the outer cone angle.

It is expedient that the (first) cone angle of all reinforcing tubes and/or the second cone angle of all reinforcing tubes is the same. In this way, a particularly simple and cost-effective production can be achieved.

It is expedient that the ratio of the average wall thickness of the reinforcing tubes to the first and/or second cone angle is ideally in the range 0.2-6 mm/°, preferably in the range 0.3-5 mm/° and particularly preferably in the range 0.4-4 mm/°. The wall thickness relevant for this is in particular the wall thickness of the respective reinforcing tube averaged in the longitudinal direction. With a ratio of the average wall thickness of the reinforcing tube to the first and/or the second cone angle in the range of 0.2-6 mm/°, a particularly simple and cost-effective production of the reinforcing tube can be achieved, resulting in a cost-effective modular forming tool. In order to achieve a particularly good compromise between positive fixing and the prevention of bursting of the surrounding component of the decisive reinforcing tube due to the interference fit, the ratio of the average wall thickness of the reinforcing tube to the first and/or second cone angle should be in a range of 0.3-5 mm/°. In order to ensure a sufficiently secure press fit even during cold joining, the ratio should be in a range of 0.4-4 mm/°.

Preferably, the ratio of the first and/or the second cone angle to the minimum longitudinal extension of a reinforcing tube in the longitudinal extension direction is in a range of 0.003-0.8°/mm, preferably in a range of 0.005-0.4°/mm and particularly preferably in a range of 0.001-0.2°/mm. In other words, the reinforcing tube should have at least some degree of longitudinal extension compared to the first and/or second cone angle. At the same time, however, too much elongation in the longitudinal direction should be avoided at certain first and/or second cone angles in order to ensure at the same time a certain manageability of the reinforcing tube, in particular during assembly. In addition, in order to also be able to tension the reinforcing tube well for machining, the ratio of the first and/or the second cone angle to the minimum length in the longitudinal extension direction of the relevant reinforcing tube should be in a range of 0.003-0.8°/mm. To achieve particularly easy joinability, the ratio of the relevant reinforcing tube should be in a range of 0.005-0.4°/mm. To also achieve particularly good joining of the reinforcing tube by cold joining, the ratio should be in a range of 0.001-0.2°/mm.

It is expedient that the ratio of the minimum inner diameter of the inner sheath surface of a reinforcing tube, in particular of all reinforcing tubes, to the wall thickness of the respective reinforcing tube lies in a range of 3-20, preferably in a range of 5-15, and particularly preferably in a range of 6-10. At a ratio in the range of 3-20, bursting or bursting open of the reinforcing tube during the joining process can be effectively avoided and/or its probability can be greatly limited. At a ratio in the range of 5-15, the applicant has surprisingly found that a particularly simple production of the reinforcing tube can be achieved by this. At a ratio of the minimum inner diameter of the sheath surface of the relevant reinforcing tube to the wall thickness of the relevant reinforcing tube in a range of 6-10, a particularly good joinability of the reinforcing tube with its surrounding component can be achieved.

Advantageously, the modular forming tool comprises at least two reinforcing tubes, preferably a plurality of reinforcing tubes, wherein at least one reinforcing tube, preferably all reinforcing tubes, of the forming tool is designed such that the surrounding reinforcing tubes have a wall thickness which is/are greater than and/or equal to the, at least directly, surrounding reinforcing tube. In this way, the increase in circumferential forces with increasing distance—in the radial direction—from the longitudinal extension direction can be taken into account. Therefore, this type of design can in particular prevent bursting open of the reinforcing tube during joining, in particular during cold joining. Advantageously, the ratio of the average wall thickness of the immediately surrounding reinforcing tube to the average wall thickness of the surrounding reinforcing tube is in a range of 1.2-1.6, because the applicant has surprisingly found that such a design leads to a cost-effective and mechanically resilient design of the modular forming tool. This ratio can be in relation to all contacting reinforcing tubes—with the immediately surrounding or surrounding reinforcing tube—and/or only in relation to two, three or four contacting pairs of reinforcing tubes.

Preferably, the inner and/or outer sheath surface of one, preferably all, reinforcing tube(s) has a roughness of Rz in the range 3 μm-20 μm, preferably in the range 4 μm-12 μm and particularly preferably 6 μm-10 μm. In particular, the condition of the reinforcing tube before it is installed in the modular forming tool is decisive for assessing the roughness. In other words, the roughness of the inner and/or outer sheath surface before contact with another component, in particular another reinforcing tube of the modular forming tool, is decisive. With a roughness of Rz in the range of 3-20 μm, a particularly good compromise between joinability and manufacturing costs can be achieved. If the roughness value of Rz is in the range 4-12 μm, this can avoid or reduce subsidence phenomena, resulting in only a slight loss of preload force. With a roughness value of Rz in the range of 6-10 μm, a particularly simple and cost-effective production of the reinforcing tube can be achieved, resulting in a particularly cost-effective modular forming tool.

It is particularly preferred if the inner sheath surface and/or the outer sheath surface of one, preferably all, reinforcing tubes in an assembled state have a roughness of Rz in the range of 1.5 μm-18 μm, preferably in a range of 3 μm-10 μm, and particularly preferably of 4 μm-8 μm. The roughness value is determined in particular by the roughness value obtained on the relevant surface after assembly with a component in contact with the surface, in particular a further reinforcing tube, a primary tool and/or a receptacle. Due to the authoritative nature of the assembled condition, slightly lower values of roughness result in comparison to the values presented above, which apply in particular to a non-joined condition. However, the advantages achievable and attainable in the areas are the same as for a non-joined component.

Another aspect of the invention may relate to a modular forming tool set, in particular for providing a modular forming tool as described above and further, wherein the modular forming tool set comprises two different primary tools and at least one reinforcing tube, wherein the reinforcing tube has a conical inner sheath surface and a conical outer sheath surface, wherein the primary tools have a workpiece machining surface, a conical sheath surface and two end surfaces, wherein the conical sheath surface of one primary tool corresponds to the conical inner sheath surface of the reinforcing tube, and wherein the conical sheath surface of the other primary tool corresponds to the conical outer sheath surface of the reinforcing tube. By forming the forming tool set in this way, a modular forming tool can be created in a simple manner, wherein in the one modular forming tool there is only the one primary tool which has a conical outer sheath surface corresponding to the conical outer sheath surface of the reinforcing tube. Therefore, in this composition of the forming tool by the forming tool set, the reinforcing tube and the other primary tool would not be present in the forming tool. In another composition of the modular forming tool set, the modular forming tool includes the other primary tool and also still includes at least the reinforcing tube. In other words, the modular forming tool set can be assembled in a simple manner by the embodiment set forth to form an embodiment with the one primary tool or to form an embodiment with the one reinforcing tube and the other primary tool. By matching the primary tools and the reinforcing tube to each other in this way, a particularly high degree of usability of the modular forming tool set can be achieved. Therefore, storage costs can be saved by designing the forming tool set in this way. In addition, a plurality of components, in particular possible further reinforcing tubes of the modular forming tool set, can be used in both the one and the other embodiment—with regard to the creation of a modular forming tool—so that the plurality of components to be kept in stock can also be reduced by such a design of the modular forming tool set.

Another aspect of the invention may relate to a press tool system comprising a first press tool and a second press tool, wherein the first and/or the second press tool may be a modular forming tool, in particular as described above and below, wherein the first press tool is a punch and/or wherein the second press tool is a die. In other words, the first press tool and/or the second press tool can be and/or comprise a modular forming tool as described above and below, so that the advantages already outlined with regard to the modular forming tool can also be achieved in one press tool.

A further aspect of the invention may relate to a method for manufacturing a modular forming tool, in particular a modular forming tool as described above and below, advantageously comprising the steps of: —providing a primary tool; —providing a reinforcing tube; —in particular applying a lubricant to the reinforcing tube and/or the primary tool; —pressing the primary tool cold and/or hot into the reinforcing tube. By means of the manufacturing method presented here, a modular forming tool can be created in a simple manner. The lubricant is applied in particular to those surfaces of the reinforcing tube and/or the primary tool which, in an assembled state, are in contact with other components. Therefore, the lubricant can be applied in particular to the inner sheath surfaces and/or the outer sheath surfaces of the reinforcing tube and/or to the sheath surface of the primary tool. Particularly preferably, the method for producing a modular forming tool also comprises the further steps of providing further reinforcing tubes, wherein advantageously the reinforcing tubes are cold and/or hot pressed into the modular forming tool in such a way that the inner sheath surface of the reinforcing tubes directly contacts and/or surrounds either a primary tool and/or a further reinforcing tube. In particular, “cold (press-fitting)” means that the components to be joined, in particular the primary tool and the reinforcing tube and/or the two reinforcing tubes to be joined, are not thermally treated before joining, in particular are not heated and/or cooled, in particular by more than 45 Kelvin. In other words, in a cold (press-fit) operation, therefore, the inner component is in particular not cooled before joining and/or the outer component to be joined is heated. In hot (press-fit) pressing, on the other hand, it is intended in particular to heat the surrounding component before pressing in, in particular by at least 45 Kelvin, and/or to cool the surrounding component, in particular the primary tool and/or the reinforcing tube, in order to reduce the latter in its extent, in particular in the radial direction. The advantage of cold pressing is that it is particularly cost-effective. In addition, cold press-fitting or cold joining also reduces the probability of bursting of the surrounding component. The advantage of hot pressing, on the other hand, is that particularly high circumferential forces can be achieved in the interference fit, which is particularly advantageous with regard to the formability or deformability of the joined component.

Further advantages and features of the present invention will be apparent from the following description with reference to the figures. Individual features of the embodiments shown can thereby also be used in other embodiments, unless this has been expressly excluded. Showing:

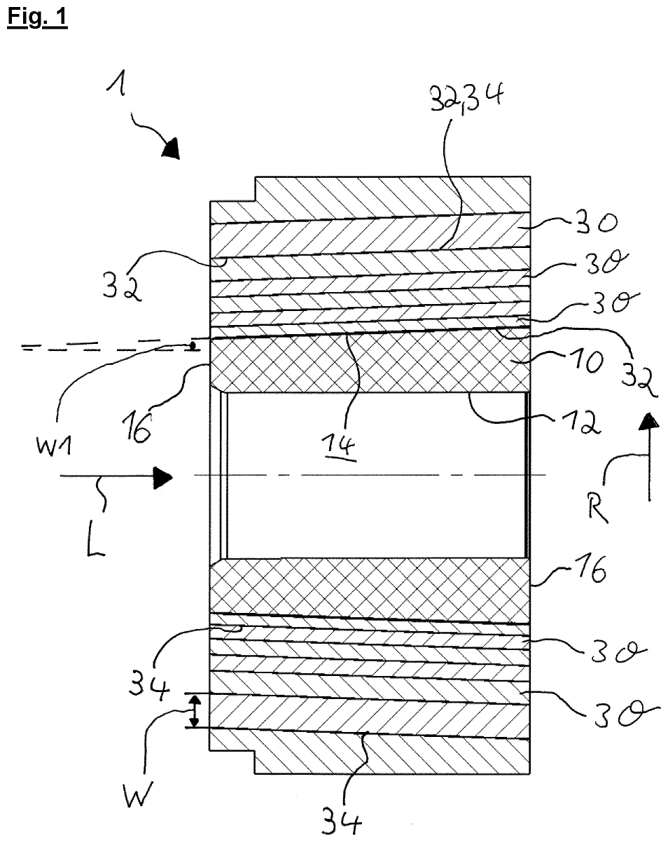

FIG. 1 a section through a forming tool;

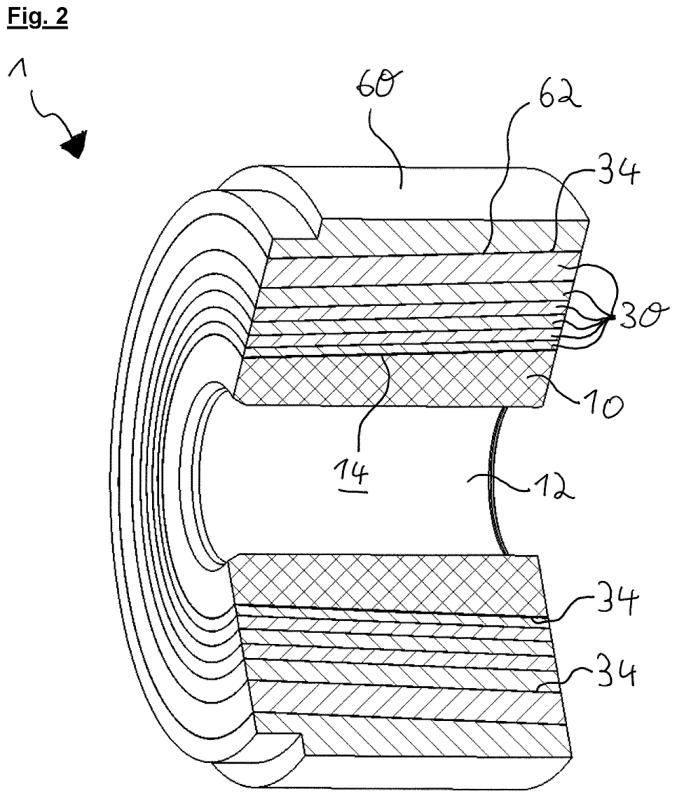

FIG. 2 a view of a forming tool with a cutout and

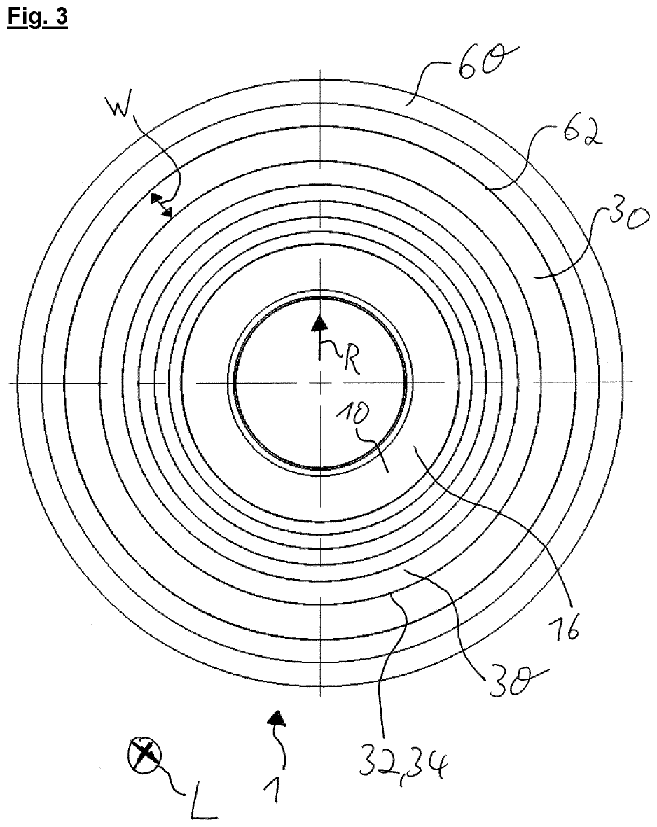

FIG. 3 a view of a forming tool in the longitudinal direction.

FIG. 1 shows a forming tool 1 which has a primary tool 10, six reinforcing tubes 30 and a receptacle 60. The forming tool 1 extends in the longitudinal direction L, with the radial direction R pointing radially away from this longitudinal direction L. The primary tool 10, which in the illustrated embodiment is a core, has a workpiece machining surface 12 which bounds the primary tool 10 inwardly in the radial direction R. In the longitudinal direction L, the primary tool 10 is bounded by the end surfaces 16, which in particular have a normal parallel to the longitudinal direction L. In radial direction R outwardly, the primary tool 10 is bounded by the sheath surface 14. In the example shown, the sheath surface 14 is completely conical. Directly contacting the conical sheath surface 14 of the primary tool 10 is the reinforcing tube 30 immediately surrounding it in the radial direction R, wherein the inner sheath surface 32 of this reinforcing tube 30 directly contacts the sheath surface 14 of the primary tool 10. The inner sheath surface 32 of this reinforcing tube 30 is thereby also completely conical in shape and has a cone angle W1 with the longitudinal direction of extension L. Radially outward in radial direction R, the reinforcing tube 30 is bounded by its outer sheath surface 34, which is also completely conical. The reinforcing tubes 30 of the forming tool 1 shown in FIG. 1 each have a conically formed inner sheath surface 32 and a conically formed outer sheath surface 34. The reinforcing tubes 30 each have a constant wall thickness W, and all reinforcing tubes 30 also have or form the same cone angle W1 with the longitudinal direction L with their inner and outer sheath surfaces 32 and 34.

In FIG. 2, an external view of a modular forming tool 1 is shown, wherein an aperture or breakout is additionally visible in order to also show the interior of the modular forming tool 1. In principle, the embodiment shown in FIG. 2 may thereby be suitable with the embodiment shown in FIG. 1. In other words, the embodiment shown in FIG. 2 may be a different view to the embodiment shown in FIG. 1. Outwardly in the radial direction R, the modular forming tool 1 is bounded by the outer receptacle 60. Formed inwardly in radial direction R in this case—similar to onion rings—are arranged reinforcing tubes 30, wherein the reinforcing tube 30 lying furthest inward in radial direction R receives or directly surrounds the primary tool 10. The reinforcing tubes 30 each have conically shaped inner sheath surfaces 32 and conically shaped outer sheath surfaces 34 in order to prevent positive displacement of the components relative to one another in the longitudinal direction L, in particular in the negative longitudinal direction L. The primary tool 10 also has a conically formed sheath surface 14 in order to prevent a positive displacement of the primary tool 10 relative to the immediately surrounding reinforcing tube 30.

FIG. 3 shows a view of a forming tool 1 in the direction of longitudinal extension L. The embodiment shown in FIG. 3 may in principle represent a different view to the embodiments already shown in FIG. 1 and/or to the embodiment shown in FIG. 2. As can be seen from FIG. 3, the primary tool 10 is surrounded by all the reinforcing tubes 30, wherein the reinforcing tubes 30 in turn are surrounded by the receptacle 60. The reinforcing tubes 30 each have a wall thickness W. In addition, the reinforcing tubes 30 also each have a conically formed outer sheath surface 34 and a conically formed inner sheath surface 32.

### LIST OF REFERENCE SIGNS

1—Forming tool
10—Primary tool
12—Workpiece machining surface
14—Sheath surface
16—End surfaces
30—Reinforcing tube
32—Inner sheath surface
34—Outer sheath surface
60—Receptacle
62—Inner contact surface
L—Longitudinal direction of extension
R—Radial direction
W—Wall thickness
W1—Cone angle

1. A modular forming tool for producing rotationally symmetrical parts, the modular forming tool comprising:
at least one primary tool,
a plurality of reinforcing tubes,
wherein the forming tool extends along a longitudinal extension direction,
wherein the primary tool has a workpiece machining surface, a sheath surface, and two end surfaces,
wherein the workpiece machining surface is adapted to contact a workpiece,
wherein the sheath surface bounds the primary tool in a radial direction,
wherein the end surfaces bound the primary tool in the longitudinal extension direction,
wherein the sheath surface of the primary tool is at least partially conical,
wherein the plurality of reinforcing tubes each have an inner sheath surface and an outer sheath surface,
wherein the inner sheath surface of at least one of the plurality of reinforcing tubes is at least partially conical in shape,
wherein the inner sheath surface contacts the sheath surface,
wherein the plurality of reinforcing tubes are formed such that one of the plurality of reinforcing tubes surrounds another one of the plurality of reinforcing tubes and the surrounding reinforcing tubes have a wall thickness that is greater than and/or equal to at least one of the reinforcing tube it surrounds, and
wherein all the reinforcing tubes are formed in such a way that they have a conical outer sheath surface.

2. Modular forming tool of claim 1,
wherein the inner sheath surfaces of the predominant part, in particular of all, reinforcing tubes are at least partially conical.

3. The modular forming tool of claim 1,
wherein the reinforcing tubes each have a constant wall thickness.

4. The modular forming tool of claim 1,
wherein a maximum inner diameter of the inner sheath surface of the surrounding reinforcing tube is substantially equal to a minimum inner diameter of the inner sheath surface of the nearest surrounding reinforcing tube.

5. The modular forming tool of claim 1,
wherein the inner sheath surface of the reinforcing tube forms a cone angle with the longitudinal extension direction,
wherein the cone angle lies in particular in a range of 0.5° to 8°.

6. The modular forming tool of claim 5,
wherein the cone angle of all of the plurality of reinforcing tubes is the same.

7. The modular forming tool of claim 5,
wherein a ratio of the mean wall thickness of the plurality of reinforcing tubes to the cone angle is in a range from 0.2 to 6 mm/°.

8. The modular forming tool of claim 5,
wherein a ratio of the cone angle to the minimum longitudinal extension of one of the reinforcing tubes in the longitudinal extension direction is in a range from 0.003 to 0.8°/mm.

9. The modular forming tool of claim 1,
wherein a ratio of a minimum inner diameter of the inner sheath surface of the reinforcing tubes to the wall thickness of the respective reinforcing tube is in a range from 3 to 20.

10. (canceled)

11. The modular forming tool of claim 1,
wherein the inner sheath surface and/or the outer sheath surface of one of the plurality of reinforcing tubes has a roughness of R_{z} in the range of from 3 μm to 20 μm.

12. The modular forming tool of claim 1,
wherein the inner sheath surface and/or the outer sheath surface of one of the plurality of reinforcing tubes in an assembled state has a roughness of R_{z} in the range from 1.5 μm to 18 μm.

13. A modular forming tool set for creating a modular forming tool, the modular forming tool set comprising
two different primary tools and a plurality of reinforcing tubes,
wherein the reinforcing tubes are formed such that one of the plurality of reinforcing tubes surrounds another one of the plurality of reinforcing tubes and the surrounding reinforcing tubes have a wall thickness which is greater than and/or equal to the surrounding reinforcing tubes,
wherein all of the plurality of reinforcing tubes are formed in such a way that they have a conical outer sheath surface,
wherein at least one reinforcing tube of the plurality of reinforcing tubes has a conical inner sheath surface and a conical outer sheath surface,
wherein the primary tools have a workpiece machining surface, a conical sheath surface, and two end surfaces,
wherein the conical sheath surface of the one primary tool corresponds to the conical inner sheath surface of the at least one reinforcing tube, and
wherein the conical sheath surface of the other primary tool corresponds to the conical outer sheath surface of the at least one reinforcing tube.

14. A press tool system comprising a first press tool and a second press tool, wherein the first and/or the second press tool is a modular forming tool of claim 1,
wherein the first press tool is a punch, and
where the second press tool is a die.

15. A method for manufacturing a modular forming tool, the method comprising the steps:
providing a primary tool,
providing a plurality of reinforcing tubes,
applying a lubricant to the reinforcing tube and/or the primary tool,
pressing the primary tool cold and/or hot into the reinforcing tube, wherein the modular forming tool comprises a plurality of reinforcing tubes,
wherein the reinforcing tubes of the modular forming tool are formed such that the surrounding reinforcing tubes have a wall thickness which is greater than and/or equal to the surrounding reinforcing tubes,
wherein all the reinforcing tubes are formed in such a way that they have a conical outer sheath surface.
